(19) United States
(12) Patent Application Publication
(10) Pub. No.: US 2006/0005359 A1
(43) Pub. Date: Jan. 12, 2006

(54) Connector device for suspending straps

(76) Inventor: Vincent Chang, Taichung (TW)

Correspondence Address: Charles E Baxley ESQ, 90 John Street 3rd Floor, New york, NY, 10038, US

(21) Appl. No.: 10/888,648

(22) Filed: Jul. 12, 2004

(51) Int. Cl. B25B 25/00

(52) U.S. Cl. 24/68 CD

(57) ABSTRACT

A connector device includes a base coupled to a strap and having a chamber formed between two side panels and having a protuberance extended from one of the side panels, a pole straddled between the side panels, a frame rotatably secured to the base with an axle and engageable with and movable over the protuberance, and another strap having an intermediate segment engaged over the pole and engaged around the frame. The frame is engageable with the other strap, to force and to tighten the strap when the frame is rotated relative to the base and locked to the base at a locking position with the protuberance.

### BACKGROUND OF THE INVENTION

1. Field of the Invention

The present invention relates to a connector device, and more particularly to a connector device for coupling or for suspending straps.

2. Description of the Prior Art

Typical connector devices for coupling or for suspending straps have been developed for coupling two straps together, and comprises a ring or loop for attaching or coupling to a lock device, and the straps are coupled to the loop and the lock device respectively, for allowing the straps to be coupled together by engaging the loop toward the lock device.

For example, U.S. Pat. No. 3,133,329 to Gaylord discloses one of the typical connector devices comprising a strap ring coupled to one of the straps, and a connector frame couple to the other strap, and the strap ring may be attached to the connector frame, and may be selectively locked to the connector frame with a swinging member and a tumbler.

However, the strap ring may only be coupled and secured to the lock device with the swinging member and the tumbler, but may not be used to straighten or tighten the straps, such that the length of the straps should be cut to the required or predetermined length before attaching to the strap ring and the lock device, and such that the straps may not be easily and quickly tightened and secured together.

The present invention has arisen to mitigate and/or obviate the afore-described disadvantages of the conventional connector devices.

### SUMMARY OF THE INVENTION

The primary objective of the present invention is to provide a connector device for allowing two straps to be easily and quickly tightened together.

In accordance with one aspect of the invention, there is provided a connector device comprising a base including a chamber formed therein and defined between two side panels and a bottom panel, one of the side panels including a protuberance extended therefrom, a pole straddled between the side panels of the base, a first strap attached to the base, a frame rotatably secured to the base with an axle, and rotatable relative to the base and engageable with and movable over the protuberance, and a second strap including an intermediate segment engaged over the pole and engaged around the frame. The frame is engageable with the intermediate segment of the second strap, to force and to tighten the second strap when the frame is rotated relative to the base and locked to the base at a locking position when the frame is moved over the protuberance, and the frame releases the intermediate segment of the second strap when the frame is rotated away from the protuberance.

The base includes a second protuberance extended from one of the side panels, to engage with the frame, and to limit the frame to rotate relative to the base.

Each of the side panels of the base includes an orifice formed therein, and the frame includes two ends rotatably engaged into the orifices of the base, to have the ends of the frame to form as the axle.

The base includes a passage formed therein, the first strap is engaged through the passage of the base and coupled to the base. The base may include the other passage formed therein, the second strap is engaged through the other passage of the base. The base includes a bar formed and defined by the passage of the base. The bar is inclined relative to the base, to facilitate an engagement of the second strap through the passage of the base.

The base includes a bulge extended into the chamber of the base from the bottom panel, to form a recess in the bulge, and to receive the second strap, and to facilitate an engagement of the second strap through the passage of the base.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a connector device in accordance with the present invention;

FIG. 2 is a perspective view of the connector device;

FIG. 3 is a cross sectional view taken along lines 3-3 of FIG. 2, having two straps attached to the connector device;

FIG. 4 is a cross sectional view similar to FIG. 3, illustrating the operation of the connector device; and

FIG. 5 is a cross sectional view similar to FIGS. 3 and 4, illustrating the other arrangement or application of the connector device.

### DETAILED DESCRIPTION OF THE PREFERRED EMBODIMENT

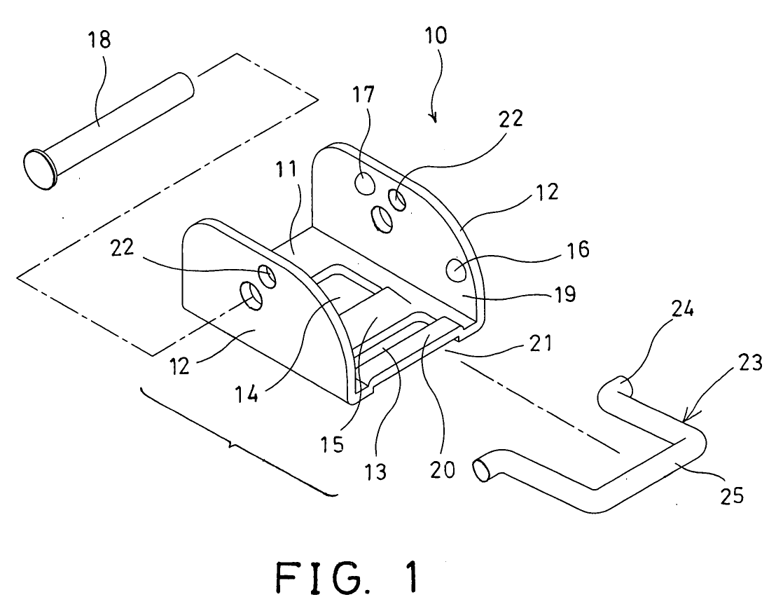

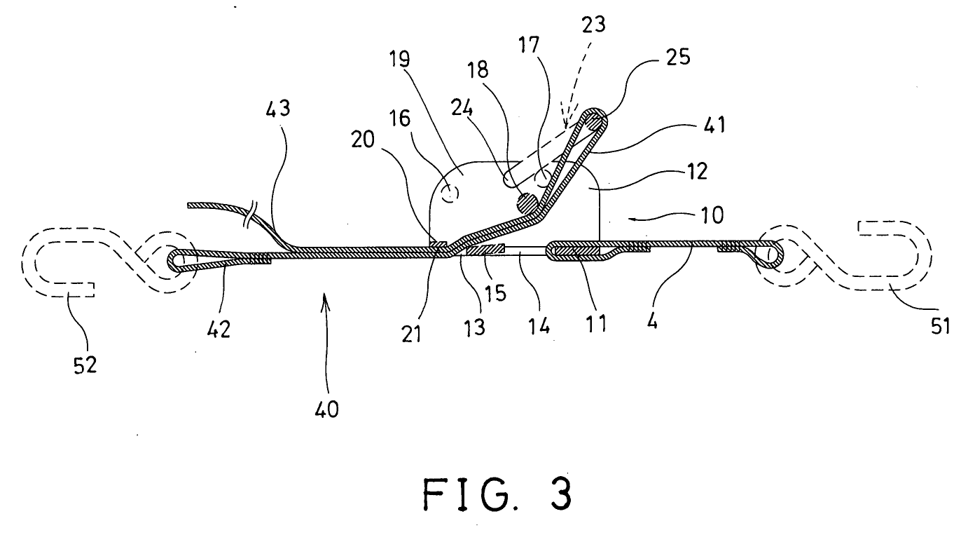

Referring to the drawings, and initially to FIGS. 1-3, a connector device in accordance with the present invention comprises a base 10 including a bottom panel 11 and two side panels 12 to form or define a chamber 19 between the side panels 12 and the bottom panel 11, and including one or more, such as two passages 13, 14 formed in the bottom panel 11 thereof, to define a bar 15 between the passages 13, 14 thereof. The bar 15 is preferably inclined relative to the bottom panel 11 of the base 10, best shown in FIGS. 3-5.

One of the side panels 12 includes one or more, such as two protuberances 16, 17 extended therefrom, such as extended into the chamber 19 of the base 10, and spaced away from each other. A pole 18 has two ends secured to the side panels 12 respectively, to allow the pole 18 to be straddled between the side panels 12. The pole 18 is preferably disposed or arranged between the protuberances 16, 17. It is preferable that the bottom panel 11 of the base 10 includes a bulge 20 extended upwardly into the chamber 19 of the base 10, to form or define a recess 21 in the bulge 20 or in the bottom panel 11 of the base 10.

Each of the side panels 12 includes an orifice 22 formed therein and aligned with each other. A frame 23 includes two ends 24 received in the chamber 19 of the base 10, and rotatably engaged into the orifices 22 of the side panels 12 respectively, to rotatably secure the frame 23 to the base 10 with an axle 24 formed or defined by the ends 24 of the frame 23, to allow the frame 23 to be rotated relative to the base 10.

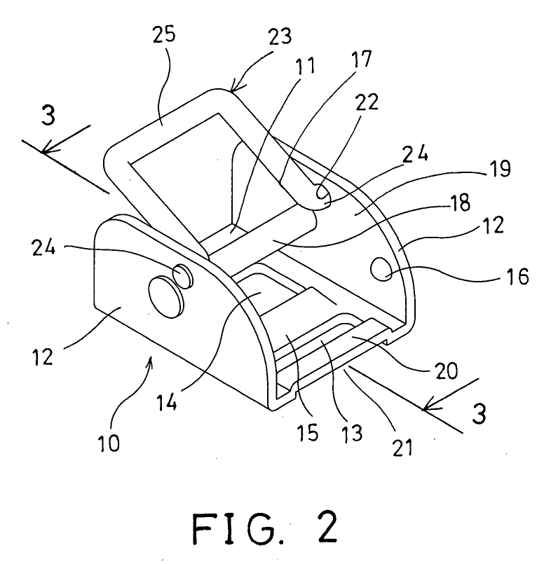

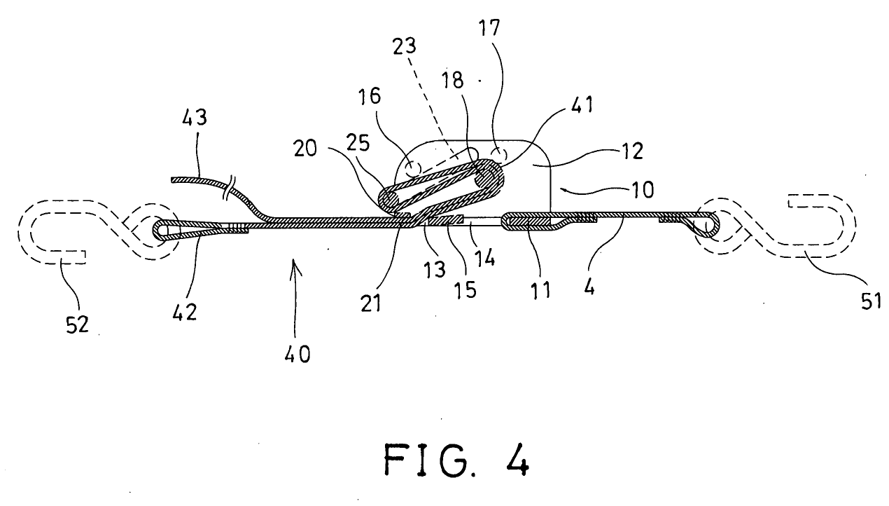

The protuberance 17 is engageable with the frame 23 (FIGS. 2, 3, 5), to limit the rotational movement of the frame 23 relative to the base 10. The protuberance 17 may be optionally provided or extended from the side panel 12, but not necessarily be provided on the side panel 12. The frame 23 is forceable over the other protuberance 16 (FIG. 4) which may retain or latch the frame 23 to the base 10 at a locking position. The protuberance 16 is required to be provided or extended from the side panel 12, to retain or latch the frame 23 to the base 10 at the locking position.

As shown in FIGS. 3 and 4, a strap 4 may be engaged through the passage 14 of the base 10, and coupled or secured to the base 10, and may be coupled to a hook 51 or the like. Another strap 40 may have an intermediate portion or segment 41 engaged through the other passage 13 of the base 10, and engaged over the pole 18 and engaged around an end rod 25 of the frame 23, and then engaged over the pole 18 again, and may have one end 42 coupled to another hook 52 or the like, and may have the other end 43 extended out of the base 10 and the frame 23.

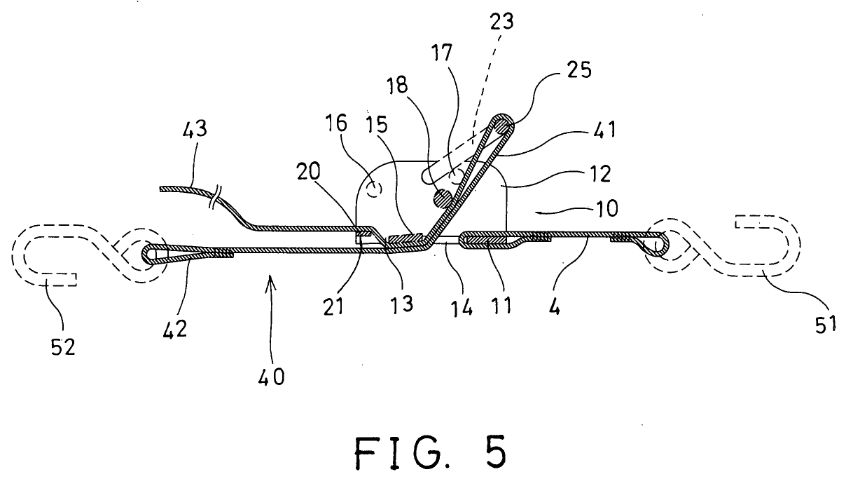

Alternatively, as shown in FIG. 5, the other strap 40 may first be engaged through the passage 14 of the base 10, and then may have the intermediate segment 41 engaged over the pole 18 and engaged around the end rod 25 of the frame 23, and then engaged over the pole 18 again, and may then be engaged through the other passage 13 of the base 10, and may have the other end 43 extended out of the base 10 and the frame 23.

The recess 21 formed in the bulge 20 or in the bottom panel 11 of the base 10 is provided to receive the strap 40, to allow the strap 40 to be easily engaged through the passage 13 of the base 10 (FIGS. 3, 4). The inclination of the bar 15 relative to the bottom panel 11 of the base 10 is arranged to allow the strap 40 to easily engaged through the other passage 14 of the base 10 (FIG. 5).

In operation, when the frame 23 is moved over the protuberance 16 and rotated relative to the base 10 toward the other protuberance 17, as shown in FIGS. 3 and 5, the frame 23 may be rotated away from the protuberance 16 to the released position as shown in FIGS. 3 and 5, such that the intermediate segment 41 of the strap 40 may be released by the frame 23, and such that the strap 40 may be pulled or tightened relative to the base 10 or the other strap 4 at this moment, by such as pulling the other end 43 of the strap 40.

After the straps 4, 40 or the hooks 51, 52 have been tightened or forced or pulled toward each other by pulling the other end 43 of the strap 40, the frame 23 may then be rotated relative to the base 10, and may be moved over the protuberance 16 to the locking position as shown in FIG. 4, and the frame 23 may thus be used to tighten the intermediate segment 41 of the strap 40. The frame 23 may thus be locked to the base 10 at the locking position by the protuberance 16.

It is to be noted that, when the frame 23 is released from the base 10 to the released position as shown in FIGS. 3 and 5, the strap 40 may be easily and quickly pulled and tightened by pulling the other end 43 thereof, and then the frame 23 may be rotated relative to the base 10 to tighten the intermediate segment 41 of the strap 40. The straps 4, 40 may thus be easily and quickly tightened and locked together by the relative movement between the base 10 and the frame 23.

Accordingly, the connector device in accordance with the present invention may be used for allowing two straps to be easily and quickly tightened together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A connector device comprising:
a base including a chamber formed therein and defined between two side panels and a bottom panel, one of said side panels including a protuberance extended therefrom,
a pole straddled between said side panels of said base,
a first strap attached to said base,
a frame rotatably secured to said base with an axle, and rotatable relative to said base and engageable with and movable over said protuberance, and
a second strap including an intermediate segment engaged over said pole and engaged around said frame, and
said frame being engageable with said intermediate segment of said second strap, to force and to tighten said second strap when said frame is rotated relative to said base and locked to said base at a locking position when said frame is moved over said protuberance, and said frame releasing said intermediate segment of said second strap when said frame is rotated away from said protuberance.

2. The connector device as claimed in claim 1, wherein said base includes a second protuberance extended from one of said side panels, to engage with said frame, and to limit said frame to rotate relative to said base.

3. The connector device as claimed in claim 1, wherein each of said side panels of said base includes an orifice formed therein, and said frame includes two ends rotatably engaged into said orifices of said base, to have said ends of said frame to form as said axle.

4. The connector device as claimed in claim 1, wherein said base includes a passage formed therein, said first strap is engaged through said passage of said base and coupled to said base.

5. The connector device as claimed in claim 1, wherein said base includes a passage formed therein, said second strap is engaged through said passage of said base.

6. The connector device as claimed in claim 5, wherein said base includes a bar formed and defined by said passage of said base.

7. The connector device as claimed in claim 6, wherein said bar is inclined relative to said base, to facilitate an engagement of said second strap through said passage of said base.

8. The connector device as claimed in claim 5, wherein said base includes a bulge extended into said chamber of said base from said bottom panel, to form a recess in said bulge, and to receive said second strap, and to facilitate an engagement of said second strap through said passage of said base.
